(19) United States
(12) Patent Application Publication
(10) Pub. No.: US 2009/0036303 A1
(43) Pub. Date: Feb. 5, 2009

(54) METHOD OF FORMING A CO-FIRED CERAMIC APPARATUS INCLUDING A MICRO-READER

(75) Inventor: Stephen R. Samms, Mesa, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/830,098

(22) Filed: Jul. 30, 2007

(51) Int. Cl. B01J 32/00

(52) U.S. Cl. 502/439

(57) ABSTRACT

A method is provided for placing high surface area catalyst material (320) within ceramic micro-reactors. The method comprises forming a first cavity (114) in a first green sheet (112) and disposing a high surface area catalyst material (320) within the first cavity (114). The first green sheet (112) is placed adjacent to a second green sheet 118 wherein the first cavity is surrounded by the first and second green sheets. At least one input channel (316) and one output channel (317) is provided to the catalyst material before the ceramic micro-reactor is fired.

### FIELD OF THE INVENTION

The present invention generally relates to ceramic micro-reactors and more particularly to a method of placing catalyst material within the ceramic micro-reactors.

### BACKGROUND OF THE INVENTION

intentionally blank

Fuel reformers have been developed for use in conjunction with various types of systems, e.g., fuel cell devices, but they are typically cumbersome and complex systems consisting of several discrete sections connected together with gas plumbing and hardware to produce hydrogen gas, and are thus not optimal for power source applications with high production volume. Recently fuel reformers have been developed utilizing ceramic monolithic structures in which the miniaturization of the reformer can be achieved. Utilizing multilayer laminated ceramic technology, ceramic components and systems are now being developed for use in microfluidic chemical processing and energy generation systems. Traditionally, multilayer ceramic structures have been used primarily for constructing “3D” circuit boards with a high degree of electronic circuitry or components embedded or integrated into the ceramic. These monolithic ceramic structures formed also have the useful properties of being relatively inert, stable to chemical reactions, and capable of tolerating high temperatures. Additionally, the ceramic materials used to form components or devices, including channeled configurations, are excellent candidates for catalyst supports and so are compatible for use in microreactor devices. An exemplary application being the generation of hydrogen for use in conjunction with fuel cell for power generation.

During steam reforming, a mixture of hydrocarbon fuel and water is catalytically converted, with the application of heat, to a hydrogen enriched fuel gas for use with fuel cells. Typically, a steam reformer is endothermically operated at an elevated temperature, for example, greater than 200° C., thereby requiring a heat source to ensure the reforming reaction is maintained in its optimal operating temperature. Common means for generating these elevated temperatures has been found using conventional electrical heaters and chemical reactors (combustors) that are physically or thermally linked to the reformation reactor.

Like most heterogeneous endothermic reactions, steam reformation reaction rates are kinetically limited and thus require high surface area catalysts in order to provide practical rates of hydrogen production. However, since the reaction takes place at elevated temperatures, the overall efficiency of the reformation reaction is, to a large degree, dependent on the heat lost from the reformer to the surroundings while the reaction is taking place. To minimize this heat loss, it is advantageous to construct a reformation reactor with a small volume to minimize the surface area through which heat is lost to the surroundings. So, while the nature of the steam reformation reaction requires high surface area, this must be done in a minimum amount of volume. Thus, the optimal catalyst for this class of reactions is one with very high surface areas contained internally within a very porous structure and the optimal reactor design is one that minimizes external surface area (and thus, system volume) while still maintaining a reasonably low pressure drop. Practically this means that the porous reformation catalyst should occupy as much of the internal reactor volume as possible by minimizing volume for plenums, heat transfer conduits, containment, and, if a wall-coated design, fluid channels down the reactor channel(s) Furthermore, because highly porous catalysts tend to have relatively low thermal conductivity, it is usually optimal for the steam reformation reactor design to minimize thermal transfer lengths between the heat source, such as a combustor, and the bulk of the reformation catalyst (the heat sink during operation). In practice, this often means constructing channels or chambers within the reformation reactor to be on the order of 1 mm or even smaller in at least 1 dimension. Commonly this type of design is often referred to as a “micro-reactor” even though external dimensions of the reactor may be much.

Traditional filling of a ceramic-based reactor with high-surface area porous catalyst has been done after the firing (sintering) of the ceramic. Typically this is done by one of three methods: 1) catalyst pellets or particles are sucked, blown, shaken or simply dropped into the reactor (resulting in a packed-bed type reactor); 2) a catalyst paste is vacuumed or pushed into the reactor after which the reactor is heated to dry the paste and/or to burn out pore formers and/or to activate binders (resulting in packed bed or porous fixed bed type reactor); or 3) catalyst slurry is put into the reactor followed by a high velocity gas purge that blows out the slurry from the center areas of the reactor followed by heating to dry the catalyst and/or activate binders (resulting in a wall-coated type reactor). Unfortunately, all of these approaches have draw backs. First and foremost is that post-fire filling of any kind involves one or more manufacturing steps that must be done after the reactor housing is formed and thus it is difficult to have full control over how optimally the catalyst is formed and located. Second, post-fire filled reactor designs often must incorporate compromises that lower overall effectiveness of the reactor in order to accommodate the post-fire filling process, e.g., extra plenums may need to be added or extra inlet/outlet added for filling that must then be capped before operation. The post-fire slurry process has the additional drawback in that the fluid mechanics for blowing out the excess slurry to form a central fluid channel results in a smaller and smaller catalyst volume fraction as the dimensions of the reactor channel are reduced. Put another way, the thickness of the resulting catalyst layer is limited by the flow dynamics of the slurry-coating process, thus possibly limiting the reactor's catalyst volume fraction below an optimal level.

Accordingly, it is desirable to provide an improved method of placing catalyst material within ceramic micro-reactors. Other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a simplified top view of a first portion of a first exemplary embodiment of a micro-reactor;

FIG. 2 is a simplified side view taken along line 2-2 of FIG. 1;

FIG. 3 is a simplified top view of a second portion of the first exemplary embodiment;

FIG. 4 is a simplified side view taken along line 4-2 of FIG. 3;

FIG. 5 is a simplified side view of the first exemplary embodiment, including the first and second portion;

FIG. 6 is a simplified sectional view of a fuel processor including a chemical combustion heater and a reactor for reforming methanol to hydrogen, both of which may be fabricated using the exemplary embodiments, and an integrated fuel cell stack;

FIG. 7 is a schematic diagram of a fuel cell system including micro-reactors in accordance with the exemplary embodiments integrated with a fuel reformer system.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A process is described herein that allows for integrating a high surface area supported catalyst into a ceramic micro-reactor without significantly changing the processing steps and without additional post-fire processing, thereby allowing for more optimal catalyst placement and loading, lower costs and reduced scrap. This process can form reactor channels with thick high surface area, e.g., non-sintering support, catalyst layers, e.g. greater than 50 micrometer, and high volume fraction of catalyst, e.g., greater than sixty percent within the reactor cavity.

The process comprises applying high surface area catalyst layers to a green-state ceramic tape, for example, by screen printing or stencil filling techniques. After printing, the ceramic tapes (with metallization, if needed) are laminated together and then fired, thereby forming a single unit. No post-processing is required for catalyst loading.

An important use of this technology is in portable power applications: specifically, fuel processors (for hydrogen generation). In the fuel processor, the endothermic reformation reaction can effectively utilize a much thicker wall-coated catalyst layer than can be utilized by corresponding heating reaction in the adjacent combustor. For portable applications, total reactor volume is critical (smaller is better) so there is a need for a mass-manufacturable technique for relatively thick wall-coated catalyst layer application that is not limited by the fluid-dynamics inherent in the traditional slurry-coated technique.

The micro-reactor manufactured in accordance with the exemplary embodiments is anticipated for use in, for example, a fuel processor, an integrated reactor system that includes one or more chemical combustion heater(s), one or more reformation reactors, and possibly additional reactors (such as a water-gas-shift reactor or a preferential oxidizer or methanation reactor) all of which may be fabricated with the exemplary embodiments. The chemical combustion heater is thermally coupled to endothermic reaction zones within the fuel processor. The micro-reactor is formed utilizing multilayer ceramic technology in which thin ceramic layers are assembled then sintered to provide for miniature dimensions in which the encapsulated catalyst(s) are utilized.

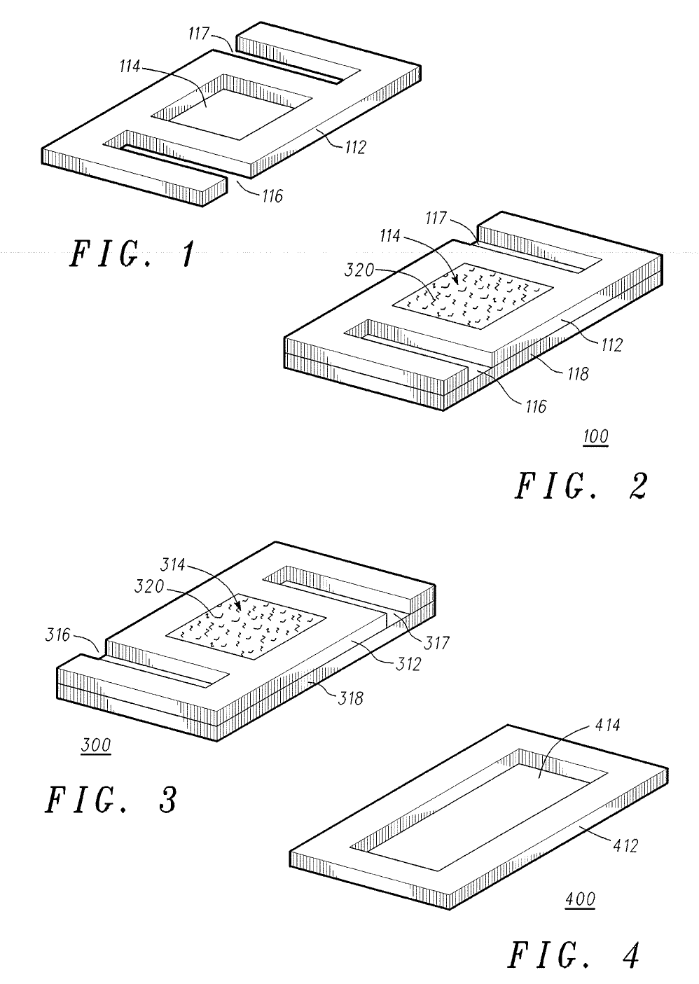

Referring to FIGS. 1 and 2 and in accordance with a first exemplary embodiment, a first green sheet layer 112 is cut to define opening 114 and channels 116, and 117 and is then positioned on a second green sheet layer 118 to form a structure 100. The first green sheet layer 112 may be formed by cutting a green ceramic sheet using a variety of methods including mechanical cutting or punching, laser or other high energy beam drilling, or simply casting or screen printing the green ceramic layer with the holes already formed. Alternatively structure 100 could be made by embossing or ablating a green ceramic layer or by injection molding or casting or some combination there of. Alternatively, structure 100 could be made by a printing or rapid prototyping technique in which a ceramic paste is printed, then cured, and then added to by printing and curing additional layers. This procedure is repeated (FIGS. 3 and 4) for third green sheet layer 312 to define opening 314 and channels 316 and 317 including placement over a fourth green sheet 318 to form a structure 300. The green sheet layers 112, 118, 312, 318 may comprise any desired thickness, but typically are cut in thicknesses of 50, 125, or 250 micrometers.

A catalyst material 320 is dispensed within the openings 114 and 314, preferably by an ink jet process to a desired thickness; however, other processes such as screen printing or stencil filling techniques could be used.

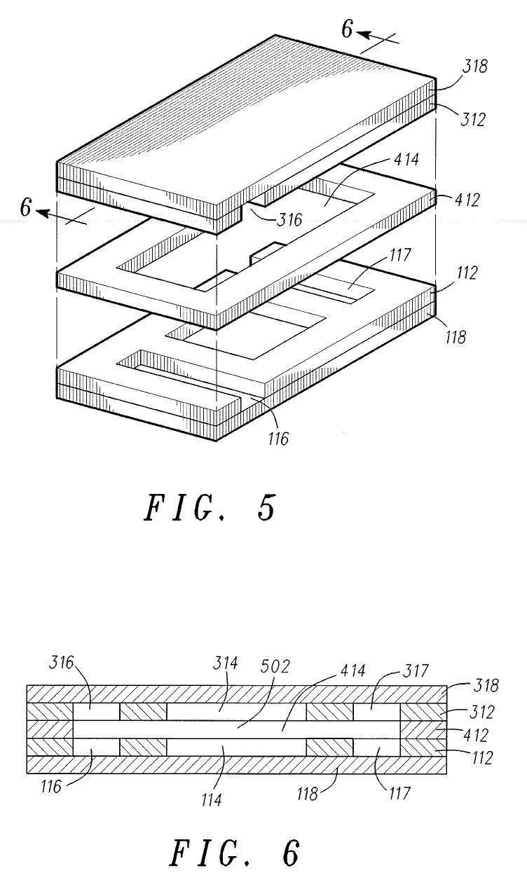

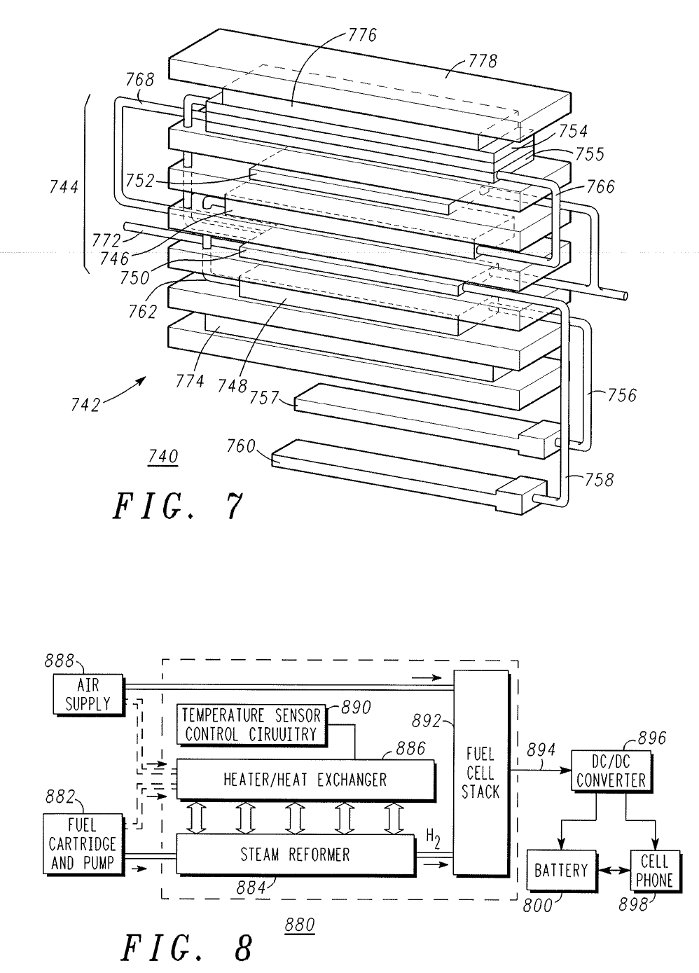

Referring to FIG. 4, another green sheet layer 412 is cut to define the opening 414. The structure 300 is flipped (FIGS. 5 and 6) and laminated on one side of the green sheet layer 412 and the structure 100 is laminated on an opposed side of the green sheet layer 412, wherein the first and third green sheet layers 112, 312 are aligned to one another so the catalyst material 320 within openings 114 and 314 are aligned with one end of opening 414, and channels 116 and 316 are aligned with the other end of the opening 414. Since the catalyst material 320 was printed only within the openings 114, 314, a gap 502 is defined by the opening 414 not occupied by the catalyst material 118, 318. Channels 116, 316 and channels 117, 317 provide an inlet and an outlet, respectively, to the gap 502, and therefore to the catalyst material 420.

Catalyst layers 320 formed using this process are typically between 50 and 1000 micrometers thick, however one of the significant advantages of this technique is that it allows construction of catalyst layers of any desired thickness. Furthermore, this pre-fired (green state) catalyst filling technique allows for the precise placement of the catalyst to ensure optimal reactor performance and does not require any additional inlets or outlets or flow channels that are sometimes required with post-fire catalyst filling techniques.

Referring now to FIG. 7, illustrated is a fuel processor 740 according to the present invention, including a plurality of microfluidic channels as well as a reformation reactor, and a chemical combustion heater, either of which could be fabricated according to any of the previously disclosed embodiments of the present invention. Fuel processor system 740 is comprised of a three-dimensional multilayer ceramic structure 742. Ceramic structure 742 is formed utilizing multilayer laminate ceramic technology. Structure 742 is typically formed in component parts which are then sintered in such a way as to provide for a monolithic housing. Ceramic structure 742 has defined therein a fuel processor, generally referenced 744. Fuel processor 744 includes a reformation-reaction zone, or fuel reformer 746, a vaporization chamber, or vaporization zone 748, and an integrated chemical combustion heater, 750. It should be understood that the high surface area catalyst(s) within the fuel reformer 746 and/or the chemical combustion heater 750 could be formed according to any of the previously disclosed embodiments herein. In addition, included as a part of fuel processor 744, is a waste heat recovery zone 752, and a fuel cell stack 754.

Ceramic structure 742 further includes at least one fuel inlet ceramic cavity 756 in fluidic communication with fuel vaporizer 748 and a liquid fuel source. At least one fuel input inlet 758 is formed to provide for fluidic communication between a fuel source 760, and combustion heater 750. It should be understood that anticipated by this disclosure is a single fuel tank that is in fluidic communication with both fuel vaporizer 748 and chemical combustion heater 750.

During operation of the fuel processor 740, fuel 757 enters fuel vaporizer 748 through a ceramic cavity 756 and is vaporized with the vaporous fuel exiting vaporizer 748 through output 762 which is in fluidic communication with fuel reformer 746. Fuel inlet 758 provides for the input of fuel to chemical combustion heater 750. An air inlet 764 provides for the input of air to chemical combustion heater 750 and to waste heat recovery zone 752. Chemical combustion heater 750 allows for complete air oxidation of fuel input 758 and subsequent dissipation of heat through structure 742 and more specifically, to fuel reformer 746 and fuel vaporizer 748.

Fuel 757 entering fuel vaporizer 748 is vaporized and the resultant vaporous methanol and water enters the reaction zone, or more specifically fuel reformer, 746 where it is converted to hydrogen enriched gas. There is provided a hydrogen enriched gas outlet channel 766 from fuel reformer 746 that is in fluidic communication with an inlet to fuel cell stack 754, and more particularly to a fuel cell anode 755. Fuel cell anode 755 provides for depletion of hydrogen from the hydrogen enriched gas mixture. This hydrogen depleted hydrogen enriched gas mixture exits fuel cell stack 754, and more particularly anode 755 through a fluidic communication 768 and is input to an inlet of chemical combustion heater 750. Chemical combustion heater 750 also oxidizes portions of this gas mixture to generate heat and provides for any uncombusted materials present, such as remaining hydrogen and carbon monoxide, to undergo air oxidation to water and carbon dioxide, and these as well nitrogen from air, are then vented through an outlet 772 away from structure 742 into the atmosphere.

Efficient thermal insulators 774 and 776 are positioned around fuel processor 744, under fuel vaporizer zone 748, and above fuel cell stack 754 to keep outer temperatures low for packaging and also to keep heat generated within the device localized to the fuel processor 744. As illustrated in FIG. 7, in this particular example, high temperature fuel cell stack 754 is integrated with fuel processor 744. This particular fuel cell design allows for the operation of the fuel cell stack at a temperature ranging from 140-230° C., with a preferred temperature of 170° C. Fuel vaporizer zone 748 operates at a temperature ranging from 120-230° C., with a preferred temperature of 180° C. and fuel reformer 746 operates at a temperature ranging from 180-300° C., with a preferred temperature of 250° C. Additionally, in this particular embodiment of fuel processor system 740, included is a top cap 778.

Finally, it is anticipated by this disclosure that although illustrated in FIG. 7 is the integration of fuel cell stack 754 with processor 744, a design in which a fuel cell is not integrated with fuel processor 744 is additionally anticipated. Further information on a reformed hydrogen fuel system device of this type can be found in U.S. patent application Ser. No. 09/649,528, entitled “HYDROGEN GENERATOR UTILIZING CERAMIC TECHNOLOGY”, filed Aug. 28, 2000, assigned to the same assignee. When fuel cell stack 754 is integrated with fuel reformer 746, advantage can be taken of the heat of the substrate to operate high temperature fuel cell stack 754. For high power applications, it is convenient to design a separate fuel cell stack 754 and a fuel processor unit 744 and couple them to supply the hydrogen enriched fuel for the fuel cell. In such instances, when a fuel cell stack is not integrated with the fuel processor, and the fuel processor is designed as a stand alone device, external connection can be made to connect the stand alone fuel processor to a traditional fuel cell stack for higher power applications.

Illustrated in FIG. 8 in a simplified block diagram 880, is the fuel processor system 740 of FIG. 7, including a multilayer ceramic structure, a fuel processor, a fuel cell stack, insulators, and fuels, similar to previously described multilayer ceramic structure 742 having a fuel processor 744, fuel cell stack 754, insulators 774 and 776, and fuels 754 and 760 of device 740. As illustrated, a fuel cartridge, generally including an optional pump mechanism 882 supplies water and methanol into a steam reformer 884, generally similar to fuel reformer 746 of FIG. 7 and a chemical combustion heater 886, generally similar to chemical combustion heater 750 of FIG. 7. An air supply 888 provides for the supplying of air to heater 886 and a fuel cell stack 892. Heater 886 is monitored by a temperature sensor, including control circuitry, 890 thereby providing for steam reformer 884 to operate at a temperature of approximately 230° C. Operation of steam reformer 884 at this temperature allows for the reforming of input fuel 882 into a reformed gas mixture, generally referred to as the hydrogen enriched gas. More particularly, in the presence of a catalyst, such as copper oxide, zinc oxide, or copper zinc oxide, the fuel solution 882 is reformed into hydrogen, carbon dioxide, and some carbon monoxide. Steam reformer 884 operates in conjunction with an optional carbon monoxide cleanup (not shown), that in the presence of a preferential oxidation catalyst and air (or 0₂), reforms a large percentage of the present carbon monoxide into carbon dioxide. This reformed gas mixture supplies fuel through a fuel output to fuel cell 892, generally similar to fuel cell stack 754 of FIG. 7. Fuel cell 892 generates electricity 894 and is illustrated in this particular example as providing energy to a DC-DC converter 896, thereby supplying power to a cell phone 898 and/or battery 800, for example.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of forming a co-fired ceramic micro-reactor, comprising:
forming a first cavity in a first green sheet;
disposing a high surface area catalyst material within the first cavity;
placing the first green sheet adjacent to a second green sheet wherein the first cavity is surrounded by the first and second green sheets;
providing at least one input channel to the catalyst material;
providing at least one output channel to the catalyst material; and
firing the ceramic apparatus.

2. The method of claim 1 wherein forming the first cavity comprises ablating to define the first and second cavity.

3. The method of claim 1 wherein forming the first cavities comprises embossing to define the first cavity.

4. The method of claim 1 wherein the forming the first cavity comprises injection molding the green sheet to define the cavity.

5. The method of claim 1 wherein the thickness of the catalyst material is greater than 50 micrometers.

6. The method in claim 1 wherein the catalyst material is made with a high surface area support material that does not substantially sinter during firing of the ceramic material.

7. The method of claim 1 wherein the first cavity is partially filled with the catalyst material, thereby defining a gap between the catalyst material and the second green sheet.

8. The method of claim 1 further comprising:
forming a second cavity in the second green sheet; and
disposing the high surface area catalyst material within the second cavity; and wherein the placing step comprises:
aligning the first and second cavities wherein the catalyst material within the first and second cavity are contiguous.

9. The method of claim 8 further comprising placing a third green sheet positioned between the first and second green sheets, the third green sheet defining a hole therethrough that is aligned between the first and second cavity to define a gap between the first and second catalyst material.

10. The method of claim 8 wherein the forming the first and second cavities comprise:
printing the first green sheet;
curing the first green sheet; and
printing the second green sheet over the first green sheet, the first green sheet defining a cavity over the first green sheet.

11. The method of claim 8 wherein the first and second cavities are partially filled with the catalyst material, thereby defining a gap between the catalyst material in the first cavity and the catalyst material in the second cavity.

12. The method of claim 11 wherein the providing at least one input channel comprises providing the at least one input channel to the gap, and the providing at least one output channel comprises providing the at least one output channel to the gap.

13. The method of claim 11 wherein the catalyst material occupies a greater than sixty percent of the volume occupied by the first cavity, the second cavity, and the gap.

14. The method of claim 13 wherein the forming the micro-reactor comprises forming a hydrocarbon reformation reaction zone.

15. The method of claim 13 wherein the disposing step comprises printing the catalyst.

16. The method of claim 13 wherein the disposing step comprises ink jet printing the catalyst.

17. The method of claim 13 wherein the disposing step comprises stencil filling the catalyst.

18. The method of claim 13 further comprising forming a fuel processor including the micro-reactor.

19. A method of forming a co-fired ceramic micro-reactor, comprising:
forming a first cavity in green ceramic, comprising:
forming a hole in a first green sheet; and
laminating the first green sheet to a second green sheet;
forming a second cavity in green ceramic, comprising:
forming a hole in a third green sheet; and
laminating the second green sheet to a fourth green sheet;
disposing a high surface area catalyst material within each of the first and second cavities;
forming a fluid access cavity by forming an opening through a fifth green sheet;
positioning the first and third green sheets adjacent the fifth green sheet wherein the first and second cavities are aligned with the opening, the opening defining a gap between the catalyst material within each of the first and second cavities;
providing at least one input channel to the gap;
providing at least one output channel to the gap; and
firing the ceramic apparatus.

20. The method of claim 19 wherein the forming a hole in the first green sheet and in the third green sheet comprises one of cutting or punching.

21. A method of forming a co-fired ceramic apparatus including a micro-reactor, comprising:
cutting a first opening through a first green sheet;
placing the first green sheet adjacent a second green sheet;
cutting a second opening through a third green sheet;
placing the third green sheet adjacent a fourth green sheet;
printing a first layer of catalyst material within the first opening and against the second green sheet to partially fill the first opening, and a second layer of catalyst material within the second opening and against the fourth green sheet to partially fill the second opening;
placing the first green sheet against the third green sheet to align the first and second openings and to define a gap between the first and second layers of catalyst materials;
forming an inlet channel into the gap;
forming an outlet channel out of the gap; and
firing the ceramic apparatus.
